(19) United States
(12) Patent Application Publication
(10) Pub. No.: US 2012/0069039 A1
(43) Pub. Date: Mar. 22, 2012

(54) TIMING CONTROLLER

(75) Inventor: Hiroyuki INOKUCHI, Ukyo-Ku (JP)

(73) Assignee: ROHM CO., LTD., Kyoto (JP)

(21) Appl. No.: 12/964,913

(22) Filed: Dec. 10, 2010

(30) Foreign Application Priority Data
Dec. 11, 2009 (JP) 2009-281815

(51) Int. Cl. G09G 5/02; G06T 1/00

(52) U.S. Cl. 345/589; 345/501

(57) ABSTRACT

A transmission method is provided for transmitting image data having pixels each comprising multiple sub-pixels provided for respective colors. The luminance of each sub-pixel provided for the corresponding color is represented by m-bit (m is an integer of 2 or more) luminance data R[m−1:0], G[m−1:0], and B[m−1:0]. Mapping is performed such that the bits provided for the same color at the same bit positions selected from the adjacent n (n represents an integer of 2 or more) pixels are sequentially arranged in the time direction so as to form a data unit. Data transmission is performed in units of data units (bit sets) thus mapped.

### BACKGROUND OF THE INVENTION

1. Field of the Invention

The present invention relates to an image data transmission technique.

2. Description of the Related Art

Liquid crystal panels include multiple data lines, multiple scanning lines arranged orthogonally to the data lines, and multiple TFTs (Thin Film Transistors) arranged in the form of a matrix, at the points of intersection of the multiple data lines and the multiple scanning lines. In order to drive the liquid crystal panel, such an arrangement includes a gate driver (scan driver) which sequentially selects the multiple scanning lines, and a source driver (data driver) which sequentially applies voltage to each of the data lines according to a luminance.

In typical arrangements configured to drive a liquid crystal panel, multiple source drivers are arranged along one side of the liquid crystal panel. The source drivers receive image data transmitted from a timing controller so as to drive the data lines. Such an arrangement uses a differential signal that conforms to the RSDS (Reduced Swing Differential Signaling) standard or the mini-LVDS (Low Voltage Differential Signaling) standard.

Typical image data includes sub-pixels of the three RGB colors for every pixel. Furthermore, each sub-pixel is configured to provide 6-bit, 8-bit, 10-bit, or 12-bit luminance data. The image data is ordered by mapping-processing, and the image data thus ordered is transmitted.

FIGS. 1A and 1B are diagrams respectively showing a mapping that conforms to the RSDS standard and a mapping that conforms to the mini-LVDS standard. Each drawing shows a case in which the R, G, and B sub-pixels each provide 6-bit luminance data.

Referring to FIG. 1A, in the RSDS standard, the data of the pixels PIX₁, PIX₂, and so on, are sequentially mapped in cycles of a period T. Directing attention to the R sub-pixel, three transmission lanes are provided. The 6-bit luminance data of which each R sub-pixel is composed is distributed to the three transmission lanes.

Referring to FIG. 1B, in the mini-LVDS standard, the pixel data is mapped in units of two adjacent pixels PIX in cycles of the period T. The bits included in each sub-pixel are transmitted in a serial manner.

### RELATED ART DOCUMENTS

### Patent Documents

### [Patent Document 1]

Japanese Patent Application Laid Open No. 2001-54067

### [Patent Document 2]

Japanese Patent Application Laid Open No. 2006-139285

### SUMMARY OF THE INVENTION

In recent years, amid mounting concern over the need to conserve energy, there is an increased demand for an image data interface circuit configured to operate with reduced power consumption. The present invention has been made in view of such a situation. It is an exemplary purpose of the present invention to provide an image transmission technique for performing image transmission with reduced power consumption.

An embodiment of the present invention relates to a timing controller configured to receive image data having pixels each comprising multiple sub-pixels provided for respective colors, and to transmit the image data thus received to a data driver, in which the luminance of each sub-pixel for the corresponding color is represented by m-bit (m is an integer of 2 or more) luminance data. The timing controller comprises: a mapping unit configured to perform mapping such that a bit set including luminance data bits of the sub-pixels provided for the same colors at the same bit positions extracted from n (n represents an integer of 2 or more) adjacent pixels are sequentially arranged in the time direction; and a transmitter configured to transmit the image data thus mapped by the mapping unit to the data driver.

In personal computer desktop images or images of scenery including blue sky, clouds, etc., there is a strong tendency for adjacent pixels to have the same color. In this case, the bits of the same color sub-pixels of these adjacent pixels have the same values at the same bit positions. Thus, the image data mapped by the timing controller according to the embodiment provides serial transmission with a reduction in the number of times bit transition occurs. Gate elements such as flip-flops and inverters consume current at a level transition timing. Such an arrangement provides a reduction in the number of times level transition occurs, thereby greatly reducing power consumption. Furthermore, such an embodiment provides a reduction in the number of times level transition occurs in the signals transmitted via a transmission line, thereby reducing noise.

Also, the timing controller and the data driver may be connected via k (k represents an integer of 2 or more) transmission lines in parallel for each color. Also, the transmitter may be configured to distribute m bit sets provided for each color to the k transmission lines so as to perform data transmission.

Another embodiment of the present invention relates to a display apparatus. The display apparatus comprises a timing controller according to any one of the aforementioned embodiments. Such an embodiment provides reduced power consumption of the display apparatus.

Yet another embodiment of the present invention relates to a data driver configured to drive data lines of a display panel based upon image data having pixels each comprising multiple sub-pixels provided for respective colors, in which the luminance of each sub-pixel for the corresponding color is represented by m-bit (m is an integer of 2 or more) luminance data. The data driver comprises: a receiver configured to receive, from a timing controller, image data mapped such that luminance data bits provided for the same colors at the same bit positions extracted from n (n represents an integer of 2 or more) adjacent pixels are sequentially arranged in the time direction; a remapping unit configured to remap the image data received from the timing controller to data arranged in units of sub-pixels; and a driving unit configured to drive the data lines based upon the data remapped by the remapping unit.

Such an embodiment provides a reduced number of times the level transition occurs in the image data to be received by the data driver. Thus, such an embodiment reduces power consumption of the data driver.

Yet another embodiment of the present invention relates to a transmission method for transmitting image data having pixels each comprising multiple sub-pixels provided for respective colors, in which the luminance of each sub-pixel for the corresponding color is represented by m-bit (m is an integer of 2 or more) luminance data. The transmission method comprises mapping such that the luminance data bits of the same colors at the same bit positions selected from n (n represents an integer of 2 or more) adjacent pixels are sequentially arranged in the time direction so as to form a data unit. With such an arrangement, data transmission is performed in units of the data units thus mapped.

Such an embodiment provides reduced power consumption and reduced noise.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are diagrams which show mapping that conforms to the RSDS standard and mapping that conforms the mini-LVDS standard, respectively;

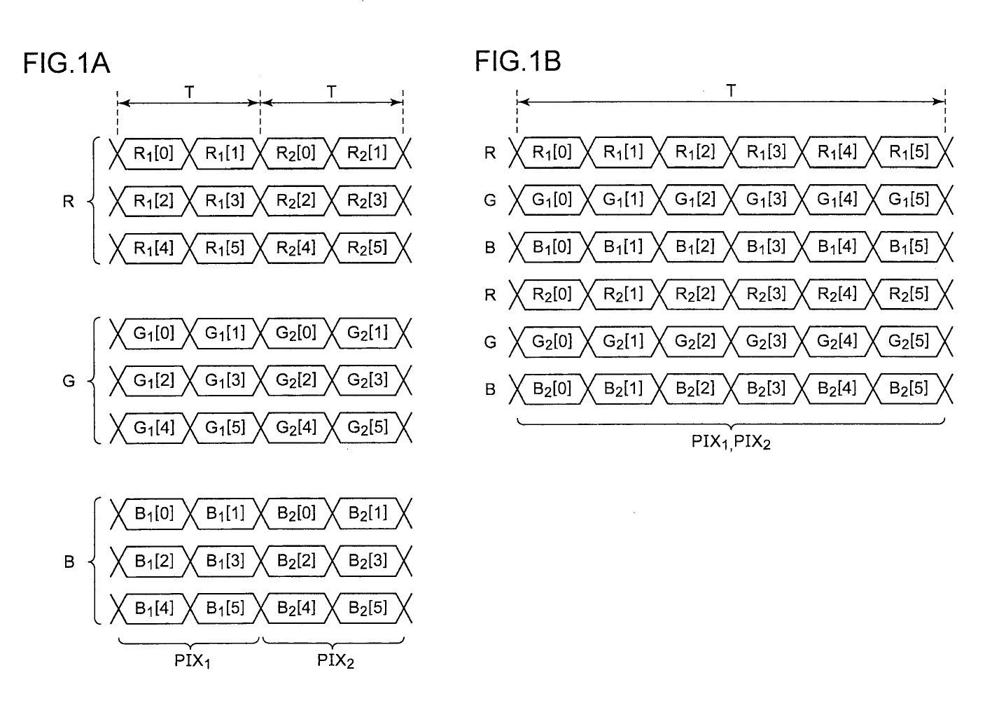

FIG. 2 is a block diagram which shows a configuration of a liquid crystal display;

FIG. 3 is a block diagram which shows a configuration of a timing controller according to an embodiment;

FIG. 4 is a diagram which shows image data mapped by a mapping unit;

FIG. 5 is a block diagram which shows a configuration of a source driver according to an embodiment;

FIGS. 6A through 6C are diagrams showing bit transition that occurs in the image data transmitted between the timing controller and the source driver; and

FIG. 7 is a diagram which shows image data mapped using parameters m=8, n=4, and k=2.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B. Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

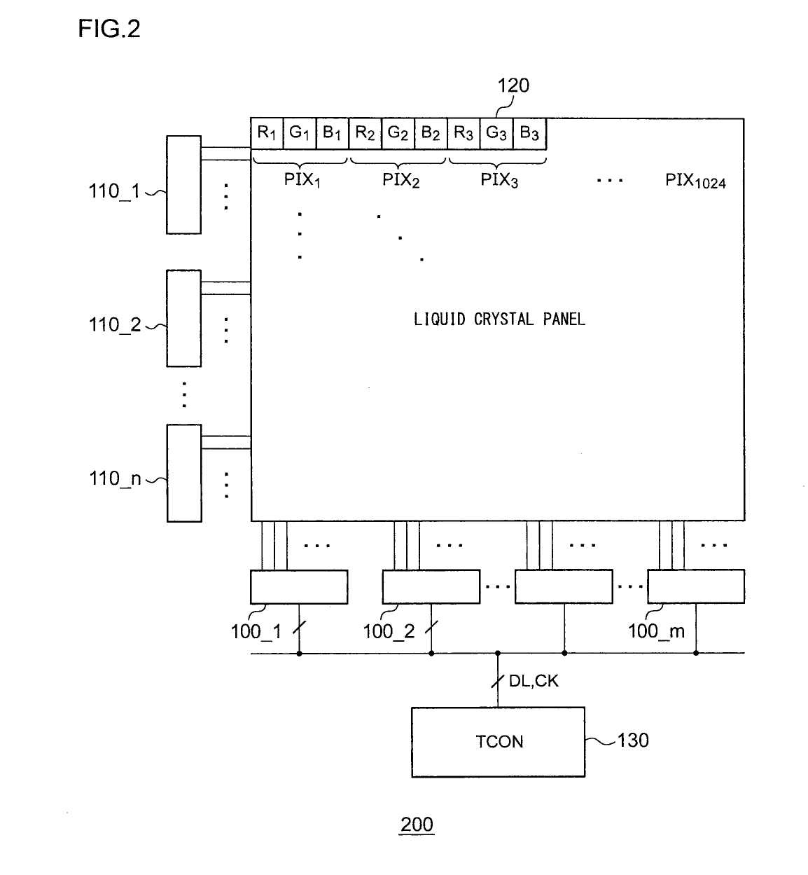

FIG. 2 is a block diagram which shows a liquid crystal display 200. The liquid crystal display 200 includes a source driver 100, a gate driver 110, a liquid crystal panel 120, and a timing controller 130.

The liquid crystal panel 120 includes multiple pixels PIX arranged in the form of a matrix. For example, an XGA panel has a configuration including 1024×728 pixels. Each pixel PIX includes sub-pixels for the three RGB colors. Sub-pixels that constitute the same pixel are arranged adjacently in the same row. That is to say, the XGA panel is configured in the form of a matrix of sub-pixels with (1024×3) sub-pixel columns horizontally and with 728 sub-pixel rows vertically. In the present specification, the i-th pixel from the upper left will be denoted by “PIXᵢ”. Furthermore, the sub-pixels that constitute the i-th pixel PIX will be denoted by Rᵢ, Gᵢ, and Bᵢ.

The liquid crystal panel 120 includes a data line for each sub-pixel column, and includes a scanning line for each sub-pixel row. The luminance levels of the R, G, and B sub-pixels are controlled according to m-bit (m represents an integer of 2 or more) data R[m−1:0], G[m−1:0], and B[m−1:0], respectively.

The timing controller 130 receives, from an unshown graphics processor, image data GD to be displayed on the liquid crystal panel 120, and controls the timing thereof so as to output the image data GD to the source driver 100. The source driver 100 drives the data lines according to the image data received from the timing controller 130. Furthermore, the gate driver 110 receives a timing signal from the timing controller 130, and sequentially applies voltage to the multiple scanning line so as to sequentially select the scanning lines.

Description will be made below regarding a technique applicable to transmission of image data between the timing controller 130 and the source driver 100.

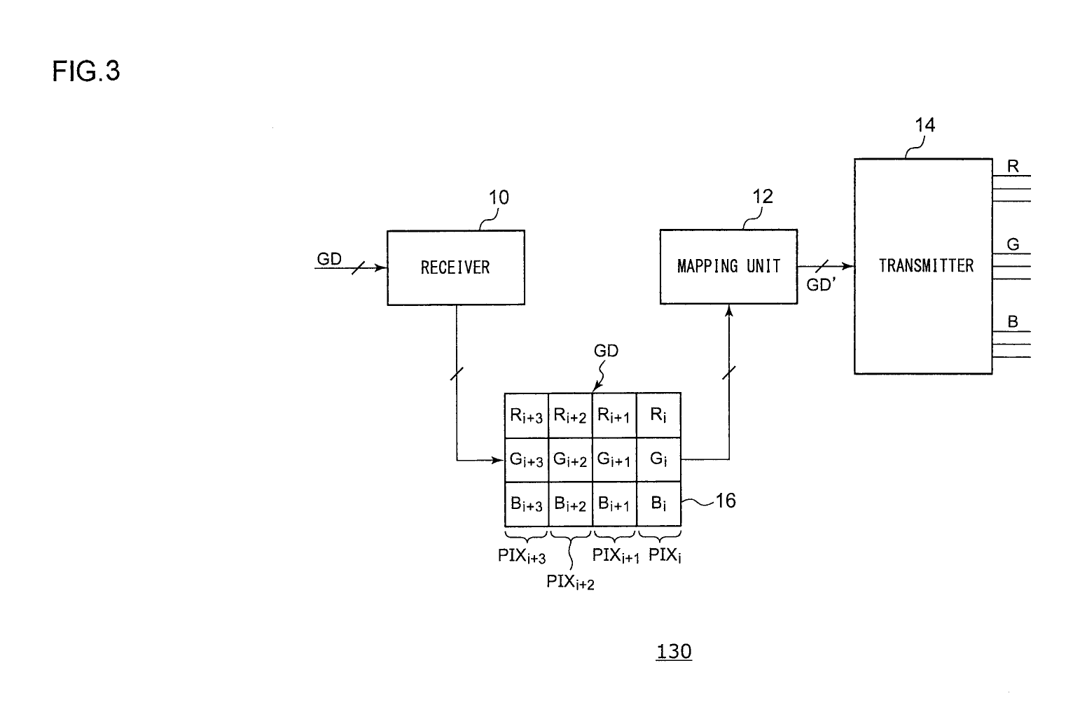

FIG. 3 is a block diagram which shows a configuration of the timing controller 130 according to an embodiment. The timing controller 130 includes a receiver 10, a mapping unit 12, a transmitter 14, and memory 16.

The receiver 10 receives the image data GD. As described above, the image data GD includes pixels PIX each including multiple sub-pixels, of the colors R, G, and B. The luminance level of each color sub-pixel is represented by m-bit (m represents an integer of 2 or more) luminance data. Description will be made regarding an arrangement in which m=6 (6-bit luminance data is employed).

The image data GD received by the receiver 10 is buffered in the memory 16 in units of data sets each comprising the pixel data PIXᵢ, PIXᵢ₊₁, PIXᵢ₊₂, and PIXᵢ₊₃ of n (hereafter, n is taken to be 4) adjacent pixels. The integer i represents 1, 5, 9, . . . , (1+n×j). For example, the memory 16 may be configured as a shift register.

The mapping unit 12 performs bit set mapping with reference to the memory 16 such that the corresponding bits included in the bit set, i.e., the bits of the same colors at the same bit positions in the four adjacent pixels PIXᵢ through PIXᵢ₊₃, are sequentially arranged in the time direction.

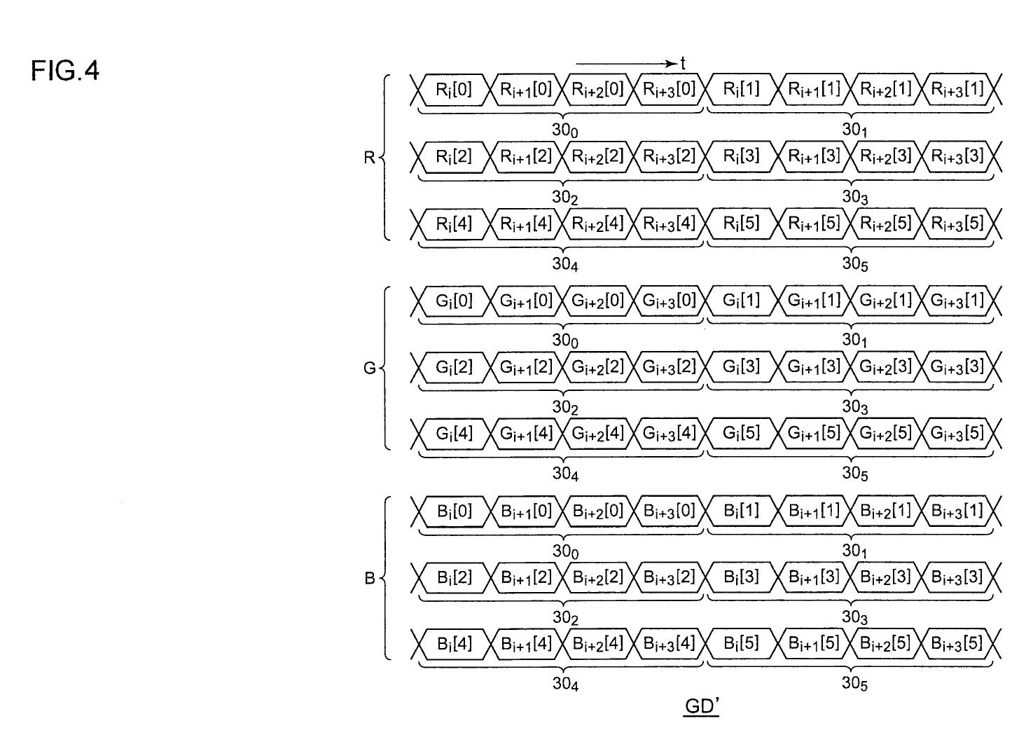

FIG. 4 is a diagram which shows image data GD′ after mapping by the mapping unit 12. For example, a bit set 30₀ is formed of the least significant bits Rᵢ[0], Rᵢ₊₁[0], Rᵢ₊₂[0], and Rᵢ₊₃[0] of the luminance data of the four adjacent red sub-pixels Rᵢ through Rᵢ₊₃, and these bits are sequentially arranged in the time direction.

Furthermore, bit sets of the same kind are formed with respect to the bits from the second-least significant bit to the most significant bit. As described above, the mapping unit 12 generates m bit sets 30₀ through 30₅ that correspond to the respective bits of the luminance data for each color sub-pixel.

The transmitter 14 shown in FIG. 3 transmits the image data thus mapped by the mapping unit 12 to the source driver 100.

The timing controller 130 is connected to each source driver 100 via k (k represents an integer of 2 or more) transmission lines TL₁ through TL₃ in parallel for each of the RGB colors. FIG. 3 shows an arrangement in which k=3. With such an arrangement, the transmitter 14 distributes the m bit sets 30₀ through 30₅ to the k transmission lines TL₁ through TL₃ for each color so as to transmit the image data. It should be noted that the layout of the bit sets 30₀ through 30₅ is not restricted in particular.

The above is the configuration of the timing controller 130. Next, description will be made regarding a configuration of the source driver 100 configured to receive the image data GD′ transmitted from the timing controller 130.

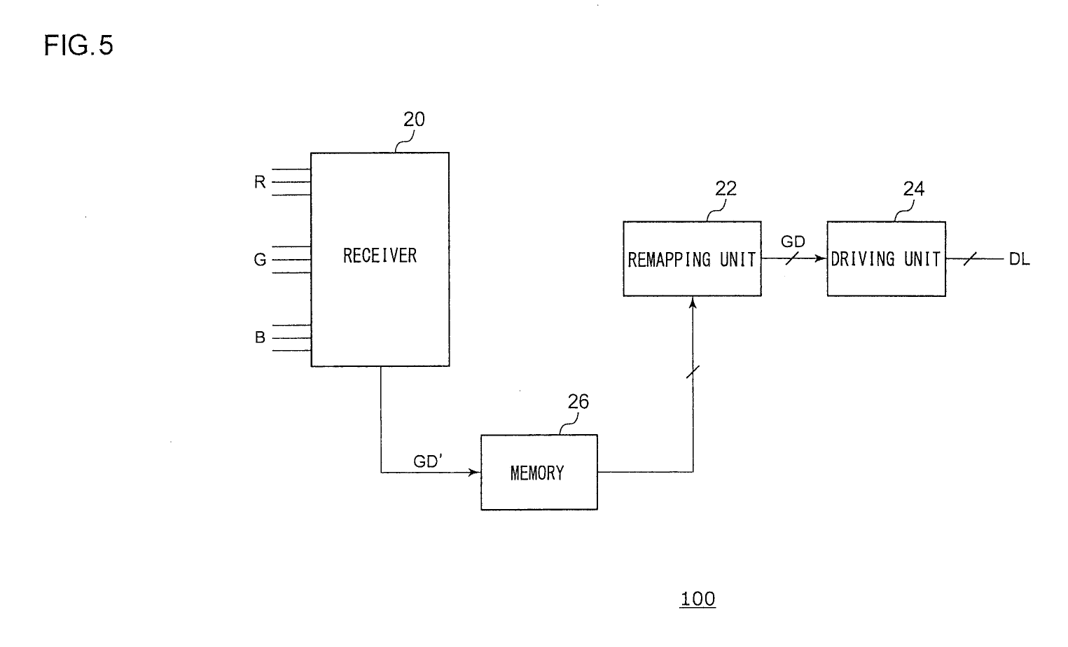

FIG. 5 is a block diagram which shows a configuration of the source driver 100 according to an embodiment. The source driver 100 includes a receiver 20, a remapping unit 22, a driving unit 24, and memory 26.

The receiver 20 receives the image data GD′ which has been mapped such that bits of the same colors at the same bit positions in the n (n represents an integer) adjacent pixels are sequentially arranged in the time direction.

The image data GD′ thus received is stored in the memory 26 in units of four adjacent pixels as shown in FIG. 4. The remapping unit 22 performs remapping of the image data GD′ to the image data GD in units of sub-pixels with reference to the image data GD′ thus stored in the memory 26. In other words, the remapping unit 22 converts the bit sets 30₀ through 30₅ thus generated in units of colors into the luminance data (Rᵢ, Gᵢ, Bᵢ), (Rᵢ₊₁, Gᵢ₊₁, Bᵢ₊₁), (Rᵢ₊₂, Gᵢ₊₂, Bᵢ₊₂), and (Rᵢ₊₃, Gᵢ₊₃, Bᵢ₊₃).

The driving unit 24 drives each data line according to the corresponding luminance data GD thus remapped by the remapping unit 22.

The above is the configuration of the source driver 100.

Next, description will be made regarding the operations of the timing controller 130 and the source driver 100. The timing controller 130 receives the image data GD from the graphics processor, maps the image data thus received to the image data GD′ as shown in FIG. 4, and transmits the image data GD′ thus mapped to the source driver 100. The source driver 100 receives the image data GD′, remaps the image data GD′ to the original image data GD, and drives the data lines.

With the timing controller 130 and the source drivers 100 according to the embodiment, by employing the above-described mapping method, such an arrangement provides reduced power consumption. Description will be made regarding the reason for this.

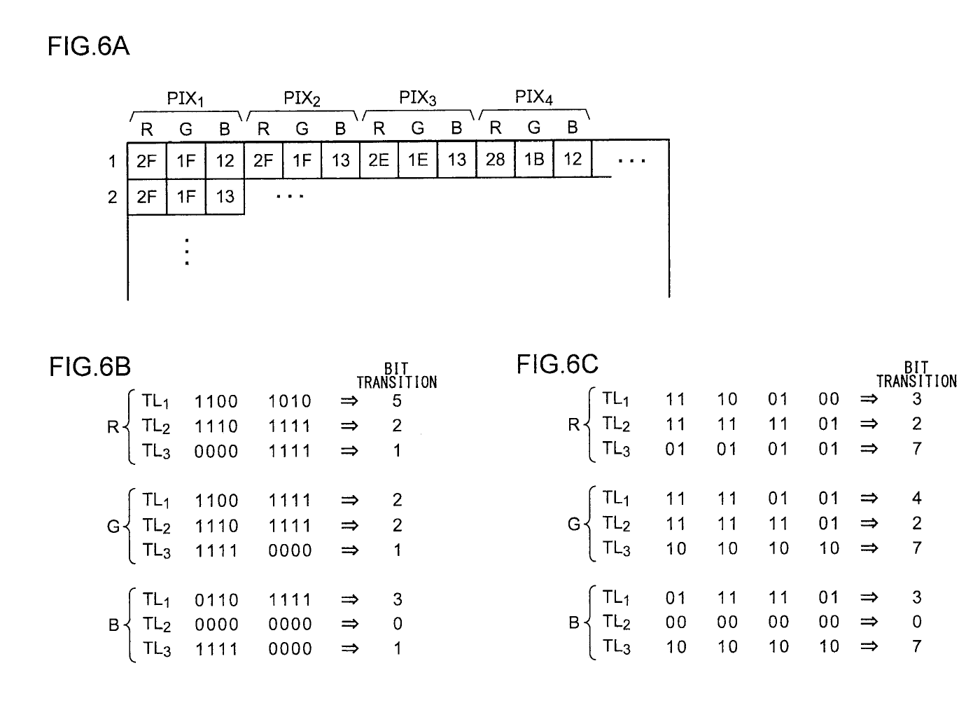

FIGS. 6A through 6C are diagrams showing bit transitions that occur in the image data transmitted between the timing controller and the source driver. FIG. 6A shows the image data to be transmitted. In personal computer desktop images or images of scenery including blue sky, clouds, etc., there is a strong tendency for adjacent pixels to have the same color. In this case, the bits of the same color sub-pixels of these adjacent pixels have the same value or very similar values at the same bit positions. FIG. 6A shows an example of such an image. Here, the luminance data of each sub-pixel is shown in hexadecimal notation.

FIG. 6B shows an example of bit transition when the first pixel PIX₁ through the fourth pixel PIX₄ of the image data shown in FIG. 6A are transmitted using the mapping method according to the embodiment. The number of times bit transition occurs in each transmission line is shown on the right-hand side of the corresponding bit sequence. It can be understood that bit transition occurs a total of 17 times in a case in which the mapping method according to the embodiment is employed.

In a case in which adjacent sub-pixels have similar luminance levels, the upper bits do no transit for each sub-pixel, and only the lower bits transit. Accordingly, the number of times bit transition occurs is greatest in the first transmission line TL₁, via which the lowest two bits are transmitted, and bit transmission occurs a small number of times in the third transmission line TL₃, via which the upper two bits are transmitted.

FIG. 6C shows an example of bit transition in a case in which the image data shown in FIG. 6A is transmitted using the RSDS-standard mapping method. In a case in which such RSDS-standard mapping is performed, bit transition occurs a total of 35 times in the transmission lines.

The power consumption of a circuit becomes greater in proportion to the number of times the bits transit. Thus, by employing the transmission method according to the embodiment, such an arrangement is capable of reducing power consumption to 17/35×100=48.5%, as compared with an arrangement using an RSDS-standard transmission method.

Furthermore, electromagnetic noise (EMI: Electro-Magnetic Interference) that occurs due to the transmission line or the transmitter becomes greater in proportion to the number of times level transition occurs. Thus, by employing the transmission method according to the embodiment, such an arrangement has an advantage of reduced EMI as compared with an arrangement employing an RSDS-standard transmission method. Thus, by employing such a transmission method, such an arrangement allows the designer of the electronic device to cut the labor required to work out the EMI problem.

The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention.

Description will be made below regarding such modifications. Description has been made in the aforementioned embodiment regarding an arrangement in which m=6, n=4, and k=3. However, the values of these parameters m, n, and k may be set to respective desired values.

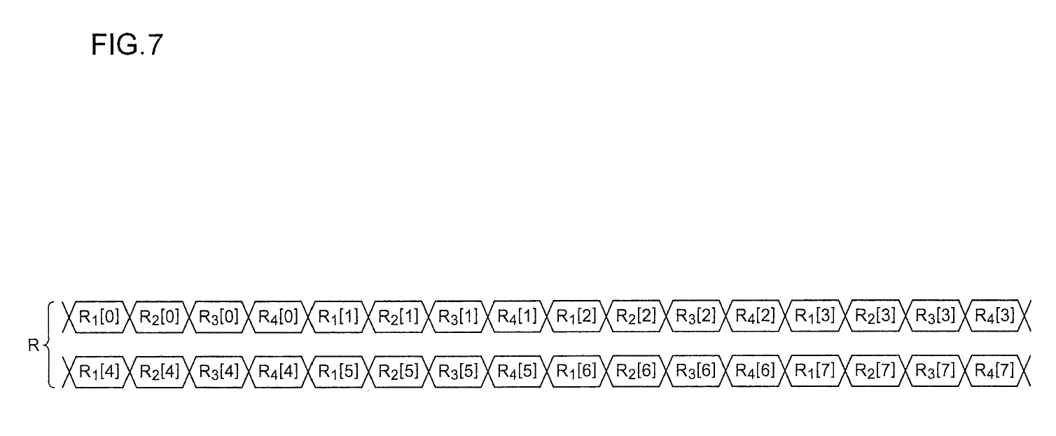

FIG. 7 is a diagram which shows image data mapped with the parameters m=8, n=4, and k=2. It should be noted that although FIG. 7 shows only the mapped R-channel image data, the G-channel image data and the B-channel image data are mapped in the same way. Also, mapping may be performed with the parameters m=6, n=8, and k=3. Also, mapping may be performed with the parameters m=8, n=8, and k=2.

Also, the number of adjacent pixels to be mapped n is not restricted to 4. Also, the number of adjacent pixels to be mapped may be set to 2, 6, 8, or the like. In a case of increasing the number of adjacent pixels to be mapped n, such an arrangement has an advantage of further reducing the number of times bit transition occurs, i.e., an advantage of further reduced power consumption. However, such an arrangement leads to a disadvantage of the increased size of memory and the increased size of a circuit to be mounted on the source driver 100 and the timing controller 130. It can be said of the number of pixels that n=4 is a value which provides an appropriate balance between the advantage of reduced power consumption and an increase in the circuit area.

Description has been made in the embodiment regarding an arrangement configured to use the transmission method according to the embodiment to perform data transmission between the timing controller 130 and the source driver 100. However, the present invention is not restricted to such an arrangement. Rather, the present invention can be applied to image data transmission between various kinds of circuit blocks. The kinds of the panels to which the present invention can be applied is not restricted to such a liquid crystal panel. Also, the present invention can be applied to various kinds of panels such as organic EL panels, plasma display panels, projector panels, etc.

While the preferred embodiments of the present invention have been described using specific terms, such description is for illustrative purposes only, and it is to be understood that changes and variations may be made without departing from the spirit or scope of the appended claims.

What is claimed is:

1. A timing controller configured to receive image data having pixels each comprising a plurality of sub-pixels provided for respective colors, and to transmit the image data thus received to a data driver, wherein the luminance of each sub-pixel for the corresponding color is represented by m-bit (m is an integer of 2 or more) luminance data, the timing controller comprising:
a mapping unit configured to perform mapping such that a bit set including luminance data bits of the sub-pixels provided for the same colors at the same bit positions extracted from n (n represents an integer of 2 or more) adjacent pixels are sequentially arranged in the time direction; and
a transmitter configured to transmit the image data thus mapped by the mapping unit to the data driver.

2. A timing controller according to claim 1, wherein the timing controller and the data driver are connected via k (k represents an integer of 2 or more) transmission lines in parallel for each color,
and wherein the transmitter is configured to distribute m bit sets provided for each color to the k transmission lines so as to perform data transmission.

3. A timing controller according to claim 2, wherein m=6, n=4, and k=3.

4. A timing controller according to claim 2, wherein m=8, n=4, and k=2.

5. A display apparatus comprising a timing controller according to claim 1.

6. A data driver configured to drive data lines of a display panel based upon image data having pixels each comprising a plurality of sub-pixels provided for respective colors, wherein the luminance of each sub-pixel for the corresponding color is represented by m-bit (m is an integer of 2 or more) luminance data, the data driver comprising:
a receiver configured to receive, from a timing controller, image data mapped such that luminance data bits provided for the same colors at the same bit positions extracted from n (n represents an integer of 2 or more) adjacent pixels are sequentially arranged in the time direction;
a remapping unit configured to remap the image data received from the timing controller to data arranged in units of sub-pixels; and
a driving unit configured to drive the data lines based upon the data remapped by the remapping unit.

7. A display apparatus comprising a data driver according to claim 6.

8. A transmission method for transmitting image data having pixels each comprising a plurality of sub-pixels provided for respective colors, wherein the luminance of each sub-pixel for the corresponding color is represented by m-bit (m is an integer of 2 or more) luminance data, the transmission method comprising mapping such that the luminance data bits of the same colors at the same bit positions selected from n (n represents an integer of 2 or more) adjacent pixels are sequentially arranged in the time direction so as to form a data unit,
wherein data transmission is performed in units of the data units thus mapped.

9. A transmission method according to claim 8, wherein m data units provided for each color are distributed to k (k represents an integer of 2 or more) transmission lines in parallel so as to perform data transmission.

10. A transmission method according to claim 9, wherein m=6, n=4, and k=3.

11. A transmission method according to claim 9, wherein m=8, n=4, and k=2.
